(19) United States
(12) Patent Application Publication
(10) Pub. No.: US 2017/0246704 A1
(43) Pub. Date: Aug. 31, 2017

(54) SPOT WELDING PROCESS WITH METALLIC ADDITION

(71) Applicants: Marcio Batista, Santo André - SP (BR); Valdir Furlanetto, Sao Paulo - SP (BR); Sergio Duarte Brandi, Sao Paulo - SP (BR)

(72) Inventors: Marcio Batista, Santo André - SP (BR); Valdir Furlanetto, Sao Paulo - SP (BR); Sergio Duarte Brandi, Sao Paulo - SP (BR)

(21) Appl. No.: 15/442,655

(22) Filed: Feb. 25, 2017

(30) Foreign Application Priority Data
Feb. 26, 2016 (BR) 1020160042321

(51) Int. Cl. B23K 11/00; B23K 11/11

(52) U.S. Cl. CPC B23K 11/002; B23K 11/115; B23K 2201/006

(57) ABSTRACT

A spot welding process which uses a metal insert as an insert between the sheets to be welded which belongs to the field of industrial welding, in order to prevent the presence of mark or indentation on the surface of the welds. After the welding process, as the metal insert material melts and dissolves between the overlapped sheets, the state of the art does not provide for the use of metal insert as an insert between the sheets, the spot welding process with insert between (2), made of metal powder or solid metal, which is introduced between the interfaces of the sheets (3) to be welded by the spot welding process, the insert (2) (3), by inert adhesive (4) or other material and process which performs this function, wherein during the melting process the metal insert (2) melts and dilutes together with the base material, i.e. the opposing metal plates (3). The alloy of the metallic insert (2) has chemical and physical properties compatible with the properties of the base metal sheets (3), the spot welding equipment requires that its contact electrodes (5) have the fully flat surfaces (6) and Or special contact geometry.

### FIELD OF INVENTION

The present patent of privilege of invention belongs to the field of industrial welding and has as its object a practical and innovative process for spot welding of sheets whose purpose is to eliminate punctiform surface deformations that appear after the welding process and which are inherent to This type of welding, widely used in the automotive, aeronautics, aerospace, railroad, naval, petrochemical, oil and gas, white goods, domestic appliances, electronics, boiler making and plating industries in general.

The spot welding process provides for the melt joining of a small area of contact between two sheets and the present technology inserts a metal insert or metal alloy, in various shapes and sizes from 0.01 micrometers up to 15 mm in thickness of a width and length of 0,01 microns up to 15 mm between metal sheets or metal alloys compatible with the physical and chemical properties of the base material to be welded by the spot welding process and thus avoid foreseeable deformations, since The melt material diffuses with the base plates and the electrodes because they are flat faced, or of special contact geometry, do not penetrate the surface of the plates and leave no apparent indentation marks which would normally be formed, if not If using the interface metal added.

It is also contemplated the use of the metal inserts or metal alloy as an insert, with the aforementioned dimensions, in laser and plasma welding processes, for melting and diluting the insert between the sheets to be welded, in application similar to spot welding.

It is also the object of the present application to present a spot welding process with the use of a metal insert or metal alloy as an insert, with low costs for its industrial feasibility, albeit with the requirements of robustness, safety and utilitarian practicality that it offers to the sector Industrial and maintenance, an additional option in the market, which unlike traditional welding processes, offers numerous possibilities and benefits to its users, becoming a process of great acceptance in the sector market.

### History of the invention

In the Resistance Spot Welding process, the overlapping parts to be welded are pressed against each other by electrodes driven by forces: mechanical, pneumatic, hydraulic or a mixture thereof.

Next, a short low voltage and high current pulse is supplied and flows through the non-consumable electrodes through the base material. The resistance of this base material to the passage of the current causes a quantity of heat in the contact surfaces of the parts proportional to the time, electrical resistance and current intensity, which should be enough to allow this region to reach the melting point of the material, forming A welded region called the weld point (Metals Handbook, 1983).

When the current flow ceases, the strength of the electrodes is still maintained while the weld metal rapidly cools and solidifies. The electrodes are retracted after each spot weld. The area where the welding current passes, the shape and diameter of the weld points generated are limited by the diameter and contour of the electrode face (Metals Handbook, 1983).

The electrical resistance at the interface between the parts is generally in the range of 50 to 500 μΩ, but may be as low as 20 μΩ for aluminum, requiring current with an intensity between 5000 A and 100,000 A for melting, which also Depends on the thermal conductivity of the metal involved, which is relatively small for steel and high for aluminum, for example.

The tensions used vary from 1 to 20 V—very rarely reach 30 V—with the application time of the current varying from less than 0.01 s for sheets (very thin sheets) to several seconds for thicker pieces (Machado, 1996) .

### THE STATE OF THE ART

Currently the spot welding processes in vehicle bodies and applications in general, as previously described, leave permanent marks, such as cavities, even after the painting process and in the case of the automobile industries, these visible marks are located Mainly on the inside of the doors, trunk lid, hood, etc., this phenomenon being called the indentation.

Occurs when the compressive strength of the material in contact with the electrode decreases as the melt is advanced, thereby allowing the face of the electrode to move into the surface of the workpiece. This indentation may be large when an electrode with a small surface area is employed with excessively high current density and pressure which, in addition to impairing the aesthetic appearance of the workpiece surface, may decrease the mechanical strength of the weld. Wu (1968)

The metal insert or interfacial metal alloy when melted and diluted with the base material allows the joining of the overlapping sheets without leaving a mark or indentation after the welding process.

### SUMMARY OF THE INVENTION

In order to obtain a spot welding that does not produce visible marks or indentation in the welding sheets, after the joining process, the inventors, people connected to the branch, with notorious sectorial knowledge, have been created to create and develop the Which is the object of the present invention, “SPOT WELDING PROCESS WITH METALLIC ADDITION” a method of welding a metal insert as a welding interface between the sheets in order to prevent the electrodes Penetrate the plates leaving a permanent mark, which are inherent in this type of welding process to the point, where not only the mechanical and functional qualities were considered in the design of its implementation, but also the welding performance and economy in the production process Which, correctly applied, brought an increase of efficiency without incurring any onus.

The innovation applied to the spot welding process incorporates a metal alloy or metal alloy insert having a shape varying in size from 0.01 micrometers to 15 mm in thickness in addition to width and length of 0.01 microns to 15 Mm, made of metals or alloys of metallic powder or with metals or solid metallic alloys, which is inserted between the interfaces of the sheets to be welded and which, when welded together, melts and dilutes to the base material which prevents That there is indentation in the welding area, with positive results in the surface finish, in other words, the welding point is not visible on the welded surfaces.

It will thus be understood that the process of spot welding with the use of metal insert or metal alloy as an insert between the sheets in question is extremely simple in its applicability and is therefore easy to be made, but is obtained Excellent practical and functional results, offering an innovative technical solution on the traditional spot welding process.

### BRIEF DESCRIPTION OF DRAWINGS

Next, for a better understanding and understanding of how the “SPOT WELDING PROCESS WITH METALLIC ADDITION” is set up, which is presented here, the following illustrative drawings are shown, where you can see:

FIG. 1—Shows a perspective view of the metal insert, which is interspersed in the welding process.

FIG. 2—It shows a perspective view of the electrode, whose contact face geometries are planned or special, used in the spot welding process with metallic insert.

FIG. 3—Shows a perspective view of the insert adhered to the plate, before being submitted to the welding process.

FIG. 4—Shows one side of two plates instant before being submitted to the spot welding process with insert of metal or metal alloy.

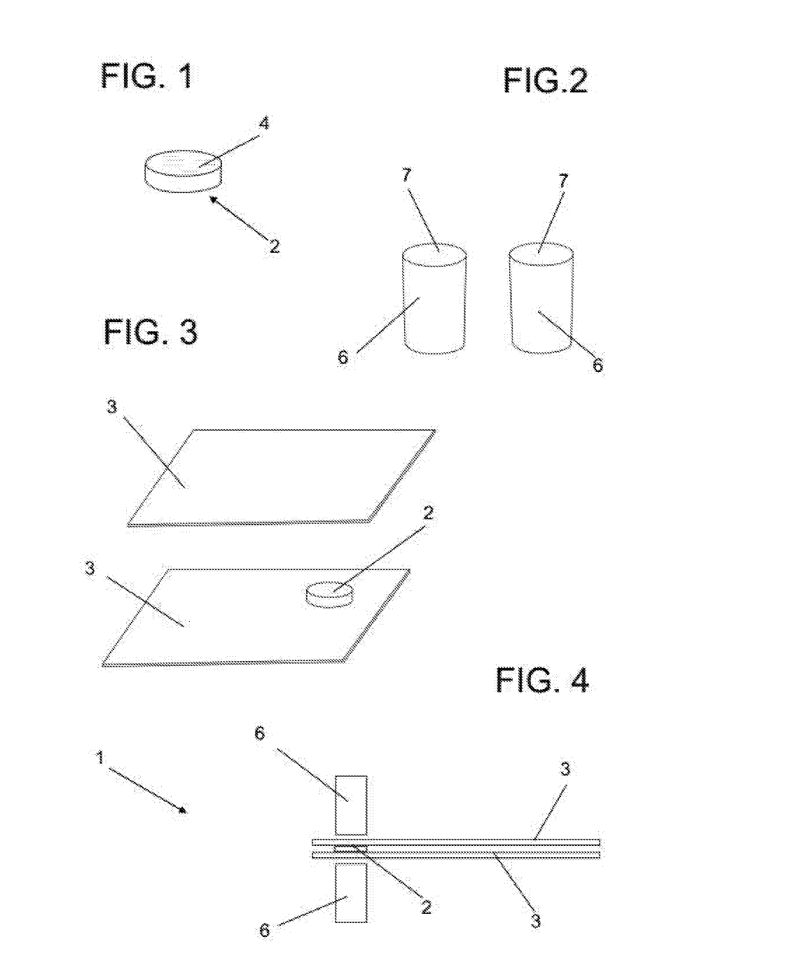

### DETAILED DESCRIPTION OF THE INVENTION

According to the above figures, the “SPOT WELDING PROCESS WITH METALLIC ADDITION”, object of the present patent, devises a resistance spot welding process using insert (2) as insert Or welding interface between the sheet areas (3) to be joined in order to avoid marks or indentation as surface cavities caused by the welding process, so that they are invisible after welding, surface treatment or painting.

The area, thickness and chemical composition of the welding insert (2) are specified in accordance with the base material to be welded, the tablet (2) being provided with an inert adhesive or other material and process which makes this (4) to be fixed to the base sheet (3), prior to welding which, being inert does not affect the performance of the welding.

Welding equipment is the same as that used in traditional spot welding, however, the contact terminals or electrodes (5) that press on the areas of the sheets to be welded, instead of having the rounded contact faces, pass through To have totally flat contact faces and or special contact geometry.

The welding inserts (2) are made of metals or alloys of metallic powder or of metals or solid metal alloys and their chemical composition are compatible with the properties of the sheets to be welded.

The spot welding process with metallic addition (1) provides for a metallic insert (2), made of metals or alloys of metallic powder or of metals or solid metallic alloys, which is introduced between the faces of the sheet area (3) to be welded by the spot welding process, the metal insert (2) being positioned on the base plate (3) by inert adhesive (4) or other material and process which performs this function.

During the melting process, the metal insert (2) is melted and diluted together with the base material, ie the opposed metal sheets (3). The alloy of the metal insert (2) has chemical and physical properties compatible with the properties of the base metal sheets (3).

Spot welding equipment requires that its contact electrodes (5) have fully flat surfaces (6) and or special contact geometry.

This report was therefore a descriptive of a new conception in the process of spot welding with a metal insert or metal alloy having, as can be seen from the analyzes carried out and figures shown, numerous differences over the conventional processes of in addition to completely different technical and functional characteristics of those pertinent to the state of the art.

For the advantages it offers, and also because it has truly innovative characteristics that fulfill all the requirements of novelty and originality in the genre, the present “SPOT WELDING PROCESS WITH METALLIC ADDITION” meets the necessary conditions to merit the patent of Privilege of Invention.

1. SPOT WELDING PROCESS WITH METALLIC ADDITION, conceives a spot welding process that does not leave marks or indentation in the sheets after the welding, being that in known processes of spot welding, the superimposed parts to be welded Are pressed against each other by means of electrodes driven by mechanical, pneumatic, hydraulic forces or a mixture thereof, then a short low voltage and high current pulse is supplied and passed through the electrodes, which are not consumable, through the base material, Wherein the method of the invention is characterized by the use of a metal insert (2) made of metals or alloys of metallic powder or of metals or solid metal alloys, which is introduced between the interfaces of the sheets (3) to be welded by (2) is positioned on the base plate (3) by inert adhesive (4) or other material and process which performs this function, wherein during the melt process the insert (2) is melted and diluted together with the base material, i.e. the opposed metal plates 3, it is emphasized that the alloy of the metal insert (2) has the chemical and physical properties compatible with the properties of the sheets (3), the spot welding equipment requires that its contact electrodes (5) have fully flat surfaces (6) and or special contact geometry.
